(19) United States
(12) Patent Application Publication
(10) Pub. No.: US 2015/0138969 A1
(43) Pub. Date: May 21, 2015

(54) COMMUNICATION APPARATUS, COMMUNICATION METHOD, AND COMPUTER-READABLE STORAGE MEDIUM

(71) Applicant: KABUSHIKI KAISHA TOSHIBA, Tokyo (JP)

(72) Inventors: Takeshi ISHIHARA, Yokohama (JP); Yuichiro OYAMA, Tokyo (JP); Hiroshi NISHIMOTO, Kawasaki (JP)

(21) Appl. No.: 14/546,148

(22) Filed: Nov. 18, 2014

(30) Foreign Application Priority Data
Nov. 20, 2013 (JP) 2013-239724

(51) Int. Cl. H04W 24/08; H04W 28/02

(52) U.S. Cl. CPC H04W 24/08; H04W 28/0215; H04W 28/0236
USPC 370/230; 370/252

(57) ABSTRACT

According to one embodiment, a communication apparatus includes a communication unit that performs radio communication with a corresponding apparatus. The communication apparatus includes a measuring unit that measures a communication state of the radio communication performed by the communicating unit. The communication apparatus includes a determining unit that determines appropriateness of data communication with the corresponding apparatus performed by the communicating unit, based on a plurality of parameters with respect to the communication state obtained by measurement made by the measuring unit.

### CROSS-REFERENCE TO RELATED APPLICATIONS

This application is based upon and claims the benefit of priority from Japanese Patent Application No. 2013-239724, filed Nov. 20, 2013; the entire contents of which are incorporated herein by reference.

### FIELD

Embodiments described herein relate generally to a communication apparatus, a communication method, and a computer-readable storage medium.

### BACKGROUND

Mobile terminal apparatuses (such as smartphones and tablet terminals) including a wireless LAN function acquire contents such as HTML files, image files, moving image files, and audio files on a content server.

At the time of acquisition, the mobile terminal apparatuses perform radio communication to transmit a content acquisition request including a predetermined universal resource identifier (URI) to the server via an access point such as a wireless LAN. The mobile terminal apparatuses acquire a content transmitted by the server in response to the content acquisition request via the access point through radio communication.

When one mobile terminal apparatus communicates with the access point, an application throughput tends to increase as a received signal strength is higher.

### BRIEF DESCRIPTION OF THE DRAWINGS

FIG. 1 is a schematic block diagram illustrating the configuration of a communication system 1 in a first embodiment.

FIG. 2 is a schematic block diagram illustrating the configuration of a communication apparatus 100 in the first embodiment.

FIG. 3 is a flow chart illustrating a first example of the processing flow of the communication apparatus 100 in the first embodiment.

FIG. 4 is a flow chart illustrating a second example of the processing flow of the communication apparatus 100 in the first embodiment.

FIG. 5A illustrates a first example of the control table.

FIG. 5B illustrates a second example of the control table.

FIG. 6 is an operation sequence chart for each component member corresponding to the flow chart of FIG. 3.

FIG. 7 illustrates a communication channel distribution of a wireless LAN using a 2.4 GHz bandwidth.

FIG. 8 is a flow chart illustrating an example of the processing flow of the communication apparatus 100 in a first modification.

FIG. 9 is a flow chart illustrating an example of the flow of processing performed after processing of the flow chart of FIG. 8.

FIG. 10 is an operation sequence chart for each component member corresponding to the flow charts of FIGS. 8 and 9.

FIG. 11 is an explanatory view illustrating issues in the second embodiment.

FIG. 12 is an explanatory view of the conditions for prefetching.

FIG. 13A is a flow chart illustrating an example of the processing flow of the communication apparatus 100 in a modification of the second modification.

FIG. 13B is a flow chart continued from the flow chart of FIG. 13A.

FIG. 14A is a flow chart illustrating an example of the processing flow of the communication apparatus 100 in a modification of the second modification.

FIG. 14B is a flow chart continued from the chart of FIG. 13A.

FIG. 15 illustrates four communications, A, B, C, and D being stored in a queue as instruction communications waiting for execution, being subjected to execution determination, and being executed.

FIG. 16 is an explanatory view of the processing of calculating the throughput for each server used as a communication counterpart.

FIG. 17 is a schematic block diagram illustrating the configuration of a communication apparatus 100b in the third embodiment.

FIG. 18 is a flow chart illustrating a first example of the process flow of the communication apparatus 100b in the third embodiment.

FIG. 19 is a flow chart illustrating a second example of the processing flow of the communication apparatus 100b in the third embodiment.

### DETAILED DESCRIPTION

According to one embodiment, a communication apparatus includes a communication unit that performs radio communication with a corresponding apparatus. The communication apparatus includes a measuring unit that measures a communication state of the radio communication performed by the communicating unit. The communication apparatus includes a determining unit that determines appropriateness of data communication with the corresponding apparatus performed by the communicating unit, based on a plurality of parameters with respect to the communication state obtained by measurement made by the measuring unit.

Hereinbelow, embodiments of the present invention will be described with reference to the accompanying drawings.

### First Embodiment

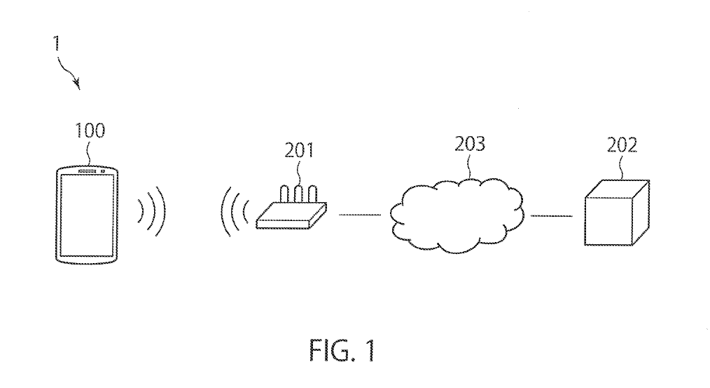

FIG. 1 is a schematic block diagram illustrating the configuration of a communication system 1 in a first embodiment. The communication system 1 includes a communication apparatus 100, a wireless access network apparatus 201 connected to the communication apparatus 100 via a wireless network, a network 203 connected to the wireless access network apparatus 201, and a corresponding apparatus 202 connected to the network 203.

The communication apparatus 100 and the wireless access network apparatus 201 can communicate with each other via a wireless network. The wireless access network apparatus 201 is connected to the network 203 through, for example, a wired LAN and the like. The wireless access network apparatus 201 and the corresponding apparatus 202 can communicate with each other via the network 203. Accordingly, the communication apparatus 100 and the corresponding apparatus 202 can communicate with each other via the wireless access network apparatus 201 and the network 203.

For example, the wireless access network apparatus 201 is an access point of a wireless LAN.

Examples of the network 203 include the Internet, an intra-enterprise network, and a local area network. Examples of the corresponding apparatus 202 include a web server.

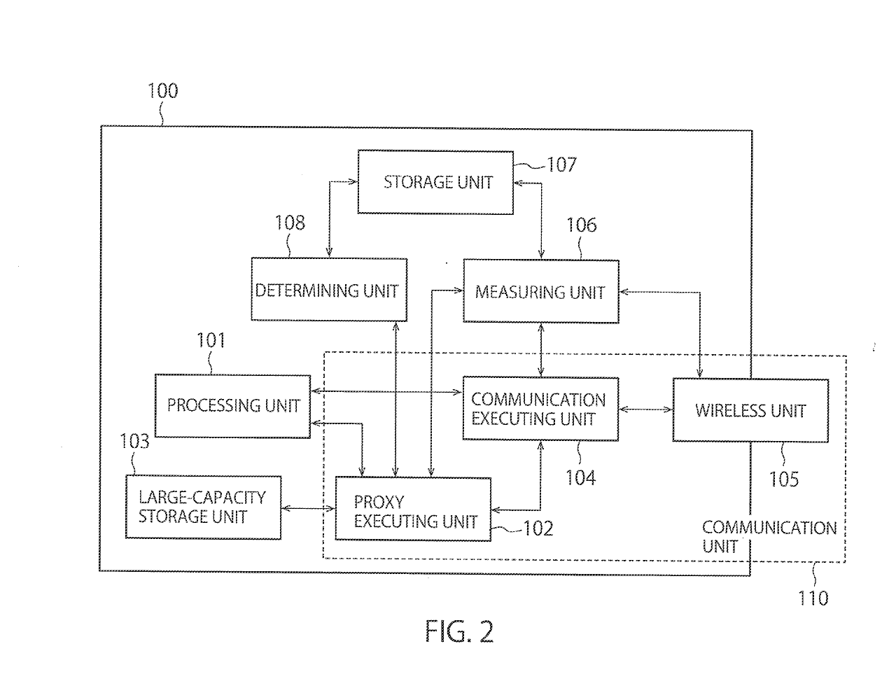

FIG. 2 is a schematic block diagram illustrating the configuration of a communication apparatus 100 in the first embodiment. FIG. 2 illustrates only those portions necessary for implementing the invention of the present application and some component members constituting a general communication apparatus and a computer system are omitted.

The communication apparatus 100 includes a processing unit 101, a communication unit 110 electrically connected to the processing unit 101, and a large-capacity storage unit 103 electrically connected to the communication unit 110.

The communication apparatus 100 further includes a measuring unit 106 electrically connected to the communication unit 110, a storage unit 107 electrically connected to the measuring unit 106, and a determining unit 108 electrically connected to the communication unit 110 and the storage unit 107.

The processing unit 101 is a processing unit which manages the entire operation of the communication apparatus 100, in which an operating system (OS) and applications operate.

The large-capacity storage unit 103 stores data which is exchanged between a proxy executing unit 102 and another communication apparatus on a network. The large-capacity storage unit 103 is a storage such as a hard disk, a solid state drive (SSD), and an SD card memory.

The communication unit 110 performs radio communication with the corresponding apparatus 202. The communication unit 110 includes: the proxy executing unit 102 electrically connected to the processing unit 101, the large-capacity storage unit 103, the determining unit 108, and the measuring unit 106; a communication executing unit 104 electrically connected to the proxy executing unit 102 and the measuring unit 106; and a wireless unit 105 electrically connected to the communication executing unit 104 and the measuring unit 106. The communication unit 110 is equivalent to a communication module.

The configuration of the communication apparatus 100 in FIG. 2 is merely an example, and the communication unit 110 may include components other than the processing unit 101.

The proxy executing unit 102 is a second processing unit having a function to execute some of application processing executed in the processing unit 101.

When a communication application is executed in the processing unit 101 and/or the proxy executing unit 102, the communication executing unit 104 executes processing for communicating with another communication apparatus on a network. In particular, the communication executing unit 104 executes communications protocols such as TCP/IP, for example.

The wireless unit 105 performs communication between the communication executing unit 104 and another communication apparatus on the network. For example, the wireless unit 105 is a wireless LAN interface in conformity with the IEEE802.11 standards.

The measuring unit 106 measures a communication state of radio communication performed by the communication unit 110. More specifically, the measuring unit 106 detects the state of each of the proxy executing unit 102, the communication executing unit 104, and the wireless unit 105, and measures their communication states.

The storage unit 107 is a memory which stores information on the measurement made by the measuring unit 106. For example, the storage unit 107 is a random access memory (RAM). The RAM may be volatile SRAM, DRAM, or a nonvolatile RAM. The storage unit 107 stores threshold values and conditions used as criteria of determination made by the determining unit 108. The threshold values and conditions used as criteria of determination may be recorded on a memory not illustrated.

The determining unit 108 determines appropriateness of data acquisition by the communication unit 110 based on a plurality of parameters with respect to the communication state obtained by measurement made by the measuring unit 106. In that case, the determining unit 108 determines appropriateness of data communication with the corresponding apparatus 202 by the communication unit 110 based on, for example, the threshold values and conditions used as the criteria of determination accumulated in the storage unit 107.

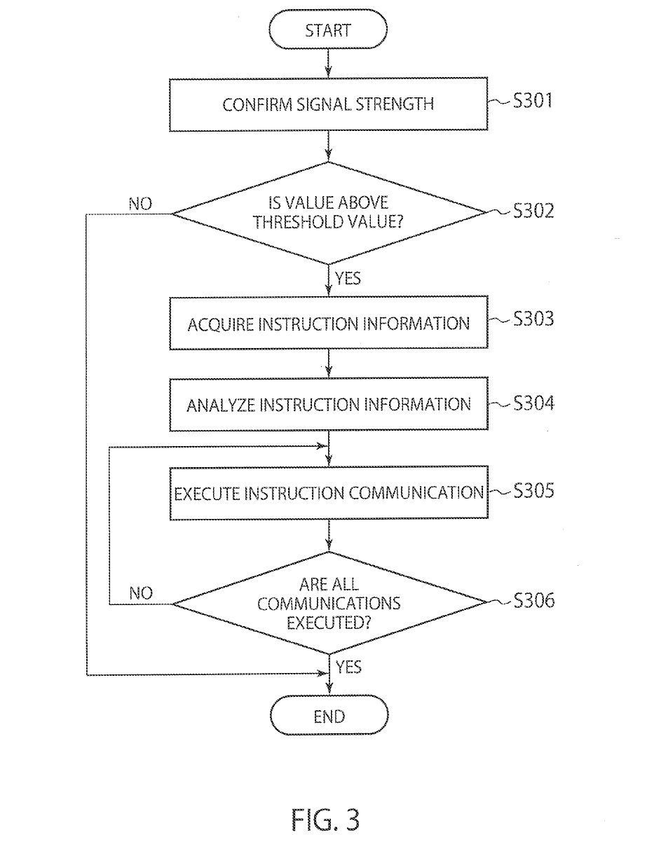

FIG. 3 is a flow chart illustrating a first example of the processing flow of the communication apparatus 100 in the first embodiment. The processing flow is executed when some kind of communication request is generated.

(Step S301) First, the measuring unit 106 measures an intensity of a radio wave received from the wireless access network apparatus 201 that is in communication session, by using radio wave intensity information obtained upon reception of a signal, such as a beacon, transmitted from the wireless access network apparatus 201.

(Step S302) The determining unit 108 then determines whether the received signal strength measured in step S301 is above a predetermined threshold value. If the received signal strength is above the predetermined threshold value (YES), the determining unit 108 proceeds to step S303. If the received signal strength is below the predetermined threshold value (NO), the determining unit 108 interrupts execution of the request and ends the processing.

(Step S303) When the received signal strength is determined to be above the predetermined threshold value in step S302, the communication unit 110 acquires instruction information from the corresponding apparatus 202 by radio communication. The instruction information (also simply called information) herein refers to information which instructs processing that the communication apparatus 100 executes. For example, the instruction information is a file, such as an HTML file and a program file, in which a content of processing to be executed in subsequent steps is described. In the case of the HTML file, URLs of a script file, an image file, and the like can be predetermined by using a tag such as <SCRIPT>tag and <IMG>tag.

(Step S304) The processing unit 101 then analyzes the instruction information. For example, when the instruction information is an HTML file, the processing unit 101 extracts a URL in the HTML file.

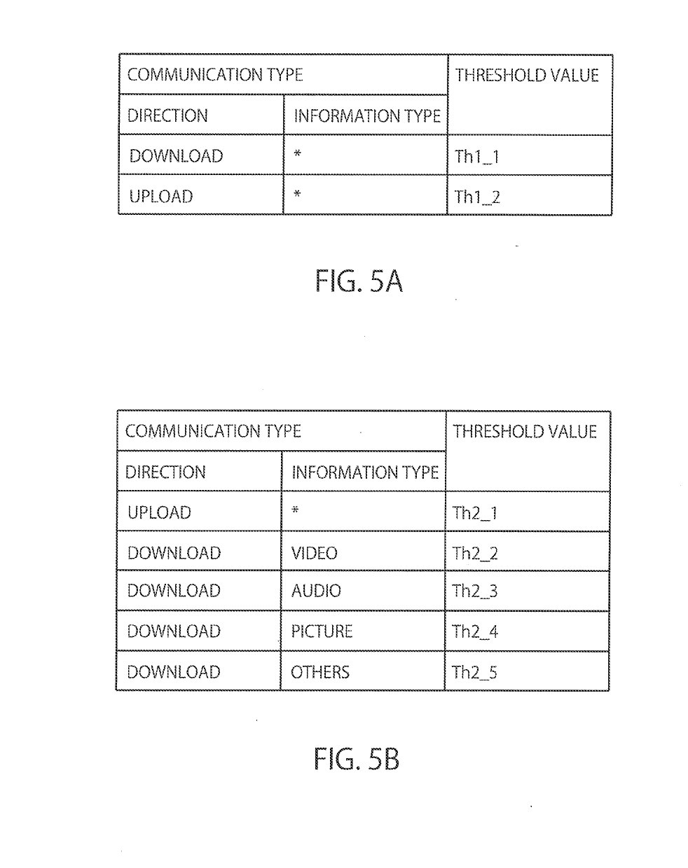

The processing unit 101 may extract an URI designated by an <A>tag in the HTML file so as to recursively acquire a page linked from the acquired page. In the case of performing recursive acquisition, the processing unit 101 may control a depth of the recursive acquisition based on a separately-set threshold value. For example, an entry of “recursive depth” may be provided in association with “direction” in FIGS. 5A and 5B. For each “recursive depth,” a threshold value may be set, such as, “Th3_{—}1” for depth 1, “Th3_{—}2” for depth 2, and “Th3_{—}3” for depth 3. The processing unit 101 may visit a link destination by depth-first search, or may visit a link destination by breadth-first search.

(Step S305) Once the content of communication which should be executed is decided in step S304, the communication unit 110 actually executes the content of the decided communication. In one example, when a URL is extracted in step S304, the communication unit 110 acquires, for example, data corresponding to the extracted URL from the corresponding apparatus 202 by radio communication.

The communication executed here may include not only a download-type communication that acquires information from the corresponding apparatus 202 but also an upload-type communication that transmits information from the communication apparatus 100 to the corresponding apparatus 202. In the case of the download-type communication, the communication unit 110 stores the acquired information in the large-capacity storage unit 103. In the case of the upload-type communication, the communication unit 110 uploads the information stored in the large-capacity storage unit 103 in response to the instruction.

When a program file execution engine is provided inside the communication apparatus 100, the communication unit 110 may download a program file described in a corresponding programming language, and the processing unit 101 may execute the program file so as to control subsequent processing. In this case, a program described in the program file may be a simple program which causes the computer to output a URL of the information to be acquired, or may be a complicated program which causes the computer to output the URL while causing the computer to control communication processing by using various pieces of information available for the communication apparatus 100. In any case, a data set which can identify, in some way, a communication method (protocol), a communication counterpart, and information to be transmitted and received is outputted. When such instruction information is used, steps S304 and S305 substantially form one processing.

(Step S306) When one time of communication is ended, the processing unit 101 confirms whether or not all the instructed communications have been executed. If all the communications have been executed (YES), the processing unit 101 ends the processing. If any process to be executed remains (NO), the processing unit 101 returns to step S305 to execute the remaining communications.

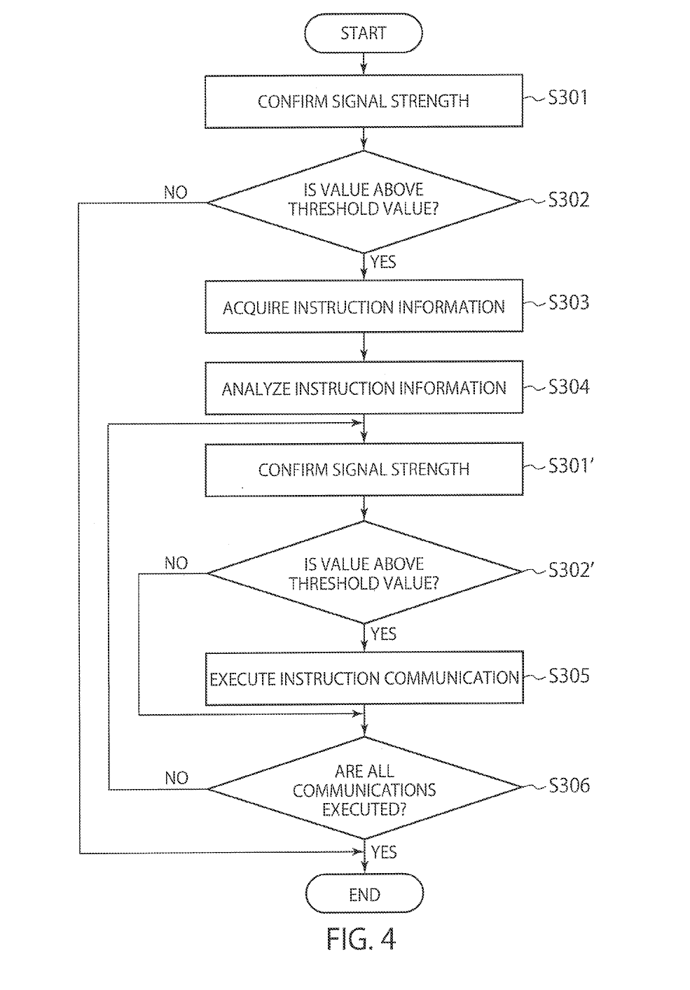

What is described above is a basic operation flow of the communication apparatus 100 in the present embodiment. In FIG. 3, the processing of confirming the received signal strength is executed only once before the instruction information is acquired. However, the processing may be executed before each time of the communication as in FIG. 4.

FIG. 4 is a flow chart illustrating a second example of the processing flow of the communication apparatus 100 in the first embodiment. Since the processing in step S301 to step S306 is the same as that of FIG. 3, a description thereof is omitted.

(Step S301′) Next, the measuring unit 106 measures an intensity of radio wave received from the wireless access network apparatus 201 that is in communication session.

(Step S302′) Then, the determining unit 108 determines whether the received signal strength measured in step S301′ is above a predetermined threshold value. If the received signal strength is above the predetermined threshold value (YES), the determining unit 108 proceeds to step S305. If the received signal strength is equal to or below the predetermined threshold value (NO), the determining unit 108 proceeds to step S306.

A plurality of threshold values may be provided in accordance with characteristics of communications to be executed, and appropriateness of execution may be determined based on the provided threshold values. In that case, the storage unit 107 may store and manage, for example, a control table as illustrated in FIGS. 5A and/or 5B.

FIG. 5A illustrates a first example of the control table. In the control table of FIG. 5A, types of communications are associated with threshold values of the received signal strength. In the example of FIG. 5A, the threshold values vary depending on communication directions (download and upload). The types of information are expressed with “*” as the types are not particularly defined.

FIG. 5B illustrates a second example of the control table. In the control table of FIG. 5B, types of communications are associated with threshold values of the received signal strength. In the example of FIG. 5B, not only threshold values are set for two types of information regarding download and upload, but also the download types are divided depending on the information types, and different threshold values are set for respective download types. In FIG. 5B, when information to be downloaded is movie data, the threshold value of the received signal strength is “Th2_{—}2.” When information to be downloaded is audio data, the threshold value of the received signal strength is “Th2_{—}3.” When information to be downloaded is image data, the threshold value of the received signal strength is “Th2_{—}4.” When information to be downloaded is other data, the threshold value of the received signal strength is “Th2_{—}5.”

In this case, when instruction information instructs download of a certain file, the determining unit 108 may determine the type of the information from an extension of the file, and read out the threshold value corresponding to the determined type of the information from the storage unit 107.

Thus, the threshold values are set in accordance with the types of information to be downloaded. Accordingly, the determining unit 108 downloads movie data when, for example, the received signal strength is relatively large, whereas when the received signal strength is relatively low, the determining unit 108 disables movie data from being downloaded. As a result, the movie data cannot be downloaded when the received signal strength is relatively small. This makes it possible to avoid repeated retry of communication and to thereby avoid loss of a battery due to the communication.

This threshold value setting is merely an example and the threshold values may be set on other conditions. Thus, the determining unit 108 may determine appropriateness of data acquisition by the communication unit 110 based on comparison between threshold values and a plurality of parameters with respect to a communication state obtained by measurement made by the measuring unit 106, the threshold values being determined by any one of a type of data corresponding to a URL, a request source (such as an application) that has made a request of transmission and reception, and a communication direction of the data corresponding to the URL. Accordingly, the threshold values are provided for, for example, each application. For example, an application handling moving images may have a threshold value of the received signal strength and a threshold value of the throughput set higher than those of other applications. As a consequence, moving images are acquired from the corresponding apparatus 202 only in the case of a favorable communication environment, so that the communication apparatus 100 can decrease power consumption.

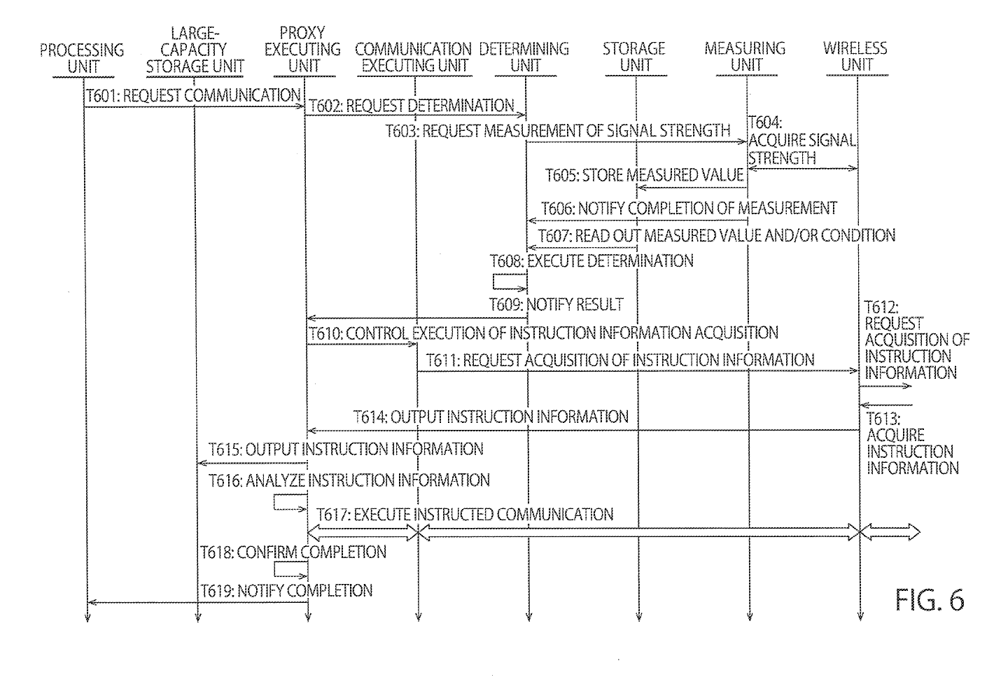

Next, the operation of internal component members of the communication apparatus 100 will be described. FIG. 6 is an operation sequence chart for each component member corresponding to the flow chart of FIG. 3.

(T601) when a communication request is generated in the processing unit 101, the processing unit 101 requests execution of communication to the proxy executing unit 102.

(T602) Next, the proxy executing unit 102 which received the request requests the determining unit 108 to determine whether or not to execute the communication based on a current radio wave intensity.

(T603) Then, the determining unit 108 requests the measuring unit 106 to measure a current received signal strength.

(T604) Next, the measuring unit 106 which received the request obtains a value of the received signal strength from the wireless unit 105.

(T605) The measuring unit 106 then stores the value of the received signal strength in the storage unit 107.

(T606) At the same time, the measuring unit 106 notifies the determining unit 108 of completion of measurement.

(T607) Upon reception of the completion of measurement, the determining unit 108 reads out from the storage unit 107 a measured value (received signal strength) and a condition (for example, a predetermined threshold value such as those described in FIG. 5A) for determination.

(T608) The determining unit 108 then determines whether the received signal strength measured in step S301′ is above the predetermined threshold value.

(T609) Next, the determining unit 108 notifies the result to the proxy executing unit 102.

(T610) If the result allows to permit the communication, the proxy executing unit 102 which received the determination result controls the communication executing unit 104 to execute acquisition of instruction information.

(T611) Under the control of the proxy executing unit 102 in T610, the communication executing unit 104 requests the wireless unit 105 to acquire the instruction information from the corresponding apparatus 202 while executing predetermined processing, such as TCP/IP processing.

(T612) The wireless unit 105 requests the instruction information from the corresponding apparatus 202.

(T613) The wireless unit 105 acquires the instruction information transmitted by the corresponding apparatus 202 in response to the request in T612.

(T614) Next, the wireless unit 105 outputs the instruction information acquired in T613 to the proxy executing unit 102.

(T615) Next, the proxy executing unit 102 stores the received instruction information in the large-capacity storage unit 103.

(T616) The proxy executing unit 102 then analyzes the received instruction information.

(T617) The proxy executing unit 102 then executes instructed communication as prefetching. Prefetching here refers to processing corresponding to the instruction information executed by the communication apparatus 100 before the request is received from the request source (processing unit 101 in this case). For example, when the instruction information is an HTML file, prefetching is to acquire data (e.g., image or movie data displayed on a WEB page) corresponding to a URL in the HTML file, before receiving the request from the request source (processing unit 101 in this case).

(T618) The proxy executing unit 102 then confirms whether or not a series of instructed communication have been completed.

(T619) Next, if the proxy executing unit 102 has confirmed completion of a series of communication in T618, the proxy executing unit 102 notifies the processing unit 101 to completion.

What is described above is a basic operation sequence of the communication apparatus 100 in the present embodiment. When determination needs to be made every time instructed communication is executed as in FIG. 4, each of the steps of T602 to T609 may be executed in T617 in each time of communication. In the sequence of FIG. 6, the measuring unit 106 measures the radio wave intensity in response to the instruction from the determining unit 108. However, the measuring unit 106 may independently performs measurement and continuously store measured values in the storage unit 107. In this case, the measuring unit 106 may record the measured values together with, for example, measuring times. The number of the measured values stored in the storage unit 107 may arbitrarily be set.

<Modification of First Embodiment: Use of Wireless LAN Information Other than Received Signal Strength>

Hereinafter, a modification of the first embodiment will be described. In the first embodiment, the determining unit 108 uses only the radio wave intensity as the information for determining appropriateness of data acquisition by the communication unit 110. Contrary to this, in the present modification, the determining unit 108 determines appropriateness of execution of communication also with other information (for example, wireless LAN information other than the received signal strength) that is available from the wireless unit 105 (for example, wireless LAN interface).

Here, examples of other information include a signal-to-noise rate (SNR), a carrier-to-noise rate (CNR), a signal-to-interference rate (SIR), a carrier-to-interference rate (CIR), a frame loss, the number of collisions, or a congestion degree.

The congestion degree is derived from, for example, the number of access points involving interfering channels among observed access points, an average number of tries during a period from start of transmission attempt to success of transmission, the number of terminals connected to the access point, the number of communication apparatuses which use the communication channel in connection, or the like. Here, the other information may be a value limited to a communication channel used by the communication apparatus, and may be a value relating to one frequency band used by the channel and other adjacent channels. Unless otherwise predetermined, the other information is used in the context of the latter.

When the determining unit 108 determines appropriateness of data acquisition by the communication unit 110, determination criteria are different in each information. However, combination of appropriate algorithms enables the determining unit 108 to determine whether or not the current environment is adequate for wireless LAN communication. For example, in the case of SIR, a larger SIR value indicates better communication quality. Therefore, it is preferable to perform communication when the SIR value is larger (this also applies to SNR/CNR/CIR). Therefore, the determining unit 108 may determine to execute data acquisition by the communication unit 110 when, for example, the received signal strength is above a predetermined threshold value, and SIR, SNR, CNR, or CIR is above respective predetermined threshold values. The determining unit 108 may determine not to execute data acquisition by the communication unit 110 when, for example, the received signal strength is equal to or below the predetermined threshold value, and/or SIR, SNR, CNR, or CIR is equal to or below the predetermined threshold value.

In the case of the frame loss and the number of collisions, a small value is considered to indicate a better communication environment. Therefore, it is preferable to perform communication when their values are small. Accordingly, the determining unit 108 may determine to execute data acquisition by the communication unit 110 when, for example, the received signal strength is above a predetermined threshold value, and the frame loss or the number of collisions is equal to or below a predetermined threshold value. The determining unit 108 may also determine not to execute data acquisition by the communication unit 110 when, for example, the received signal strength is equal to or below the predetermined threshold value, and/or the frame loss or the number of collisions is above the predetermined threshold value.

These information sets may be used by themselves in place of the received signal strength in the first embodiment. In the case of determining appropriateness of communication by using a plurality of indices, priority of the indices may be set in advance and determination may be performed in order of the priority. For example, the determining unit 108 may determine whether SIR is above a predetermined threshold value only in the case where the received signal strength, which can easily be measured, is used as a first index and it can be confirmed that the radio wave intensity is above the threshold value.

Moreover, a plurality of parameters used by the determining unit 108 may include a first parameter relating to a first communication channel that is directly connected to the communication apparatus 100. The parameters may also include a second parameter relating to either communication channels including a second communication channel from the wireless access network apparatus 201 to the corresponding apparatus 202 when the communication unit 110 communicates with the corresponding apparatus 202 via the wireless access network apparatus 201, or a third communication channel having a difference in frequency from that of the first communication channel that is directly connected to the communication apparatus 100, the difference in frequency being within a predetermined range. In that case, the determining unit 108 may determine appropriateness of data acquisition by the communication unit 110 based on the first parameter and the second parameter.

Moreover, in one example, the first parameter may be a parameter indicative of an intensity of a signal from the wireless access network apparatus 201 connected to the communication apparatus 100. The second parameter may be a parameter relating to the third communication channel. In that case, the parameter relating to the third communication channel is a parameter relating to an interference radio wave from other equipment that uses a frequency band same or adjacent to a frequency used by the communication apparatus 100 to communicate with the wireless access network apparatus 201, and/or a parameter relating to an adjacent communication channel that is adjacent to a communication channel directly used by the communication apparatus 100 to communicate with the wireless access network apparatus 201. In one example, the parameter relating to the adjacent communication channel is a radio wave intensity in a radio communication channel adjacent to the radio communication channel used for communication with the wireless access network apparatus 201.

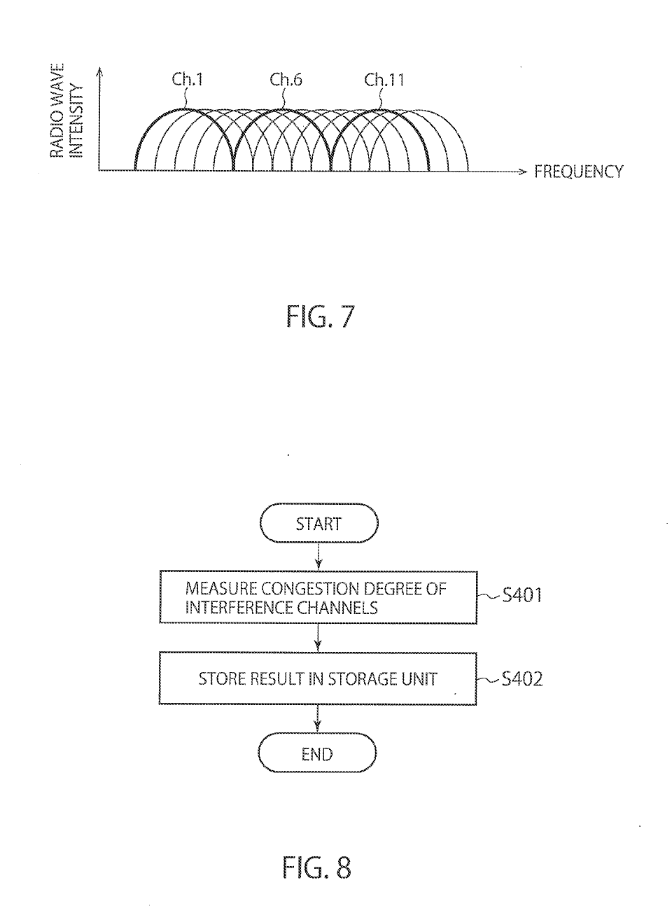

Hereinafter, a description is given of the case, as an example, where the above-stated parameter relating to the third communication channel is the radio wave intensity of a radio communication channel adjacent to the radio communication channel used for communication with the wireless access network apparatus 201. FIG. 7 illustrates a communication channel distribution of a wireless LAN using a 2.4 GHz bandwidth. A portion overlapped with each other indicates interfering radio waves. Assuming that the communication apparatus 100 uses Channel 6, a radio wave emitted by the communication apparatus 100 interferes with radio waves in Channels 2 to 5 and 7 to 10. The measuring unit 106 uses the wireless unit 105 to perform processing to confirm the status of the channels which may interfere, and stores the result in the storage unit 107. It is considered that this processing takes a certain amount of time. If the confirming processing is performed after the measuring unit 106 receives a communication request from the proxy executing unit 102, a large amount of delay may be generated by the time when the communication is started. Accordingly, the measuring unit 106 performs this processing in advance, for example. Here, the status of the channel is, for example, a congestion degree of apparatuses which emit radio waves (the number of other apparatuses, such as access points, which emit radio waves in one example).

Once a communication request is actually generated from the proxy executing unit 102, the measuring unit 106 confirms the radio wave intensity of the channel to be used for communication. If the value is above a predetermined threshold value (if the radio wave intensity is determined to be adequate), the determining unit 108 confirms a latest status regarding other interfering channels stored in the storage unit 107 so as to confirm the congestion degree. If the radio wave intensity is low, the determining unit 108 does not perform confirmation of the congestion degree.

In one example, the determining unit 108 also compares the congestion degree with a predetermined threshold value. For example, when the congestion degree of other interfering channels is below the threshold value, the determining unit 108 determines that the current status is adequate for communication, and returns the determination to the proxy executing unit 102. When the congestion degree of other interfering channels is higher than the threshold value, for example, the determining unit 108 determines that the current status is not adequate for communication, and returns the determination to the proxy executing unit 102.

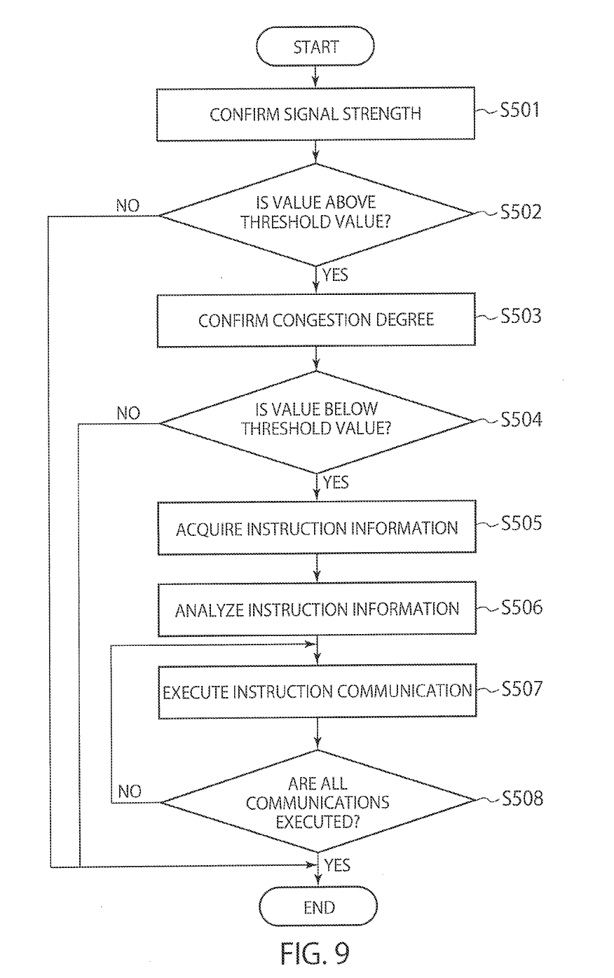

FIGS. 8 to 9 are flow charts of the above-mentioned operation. FIG. 8 is a flow chart illustrating an example of the processing flow of the communication apparatus 100 in a first modification. FIG. 9 is a flow chart illustrating an example of the flow of processing performed after processing of the flow chart of FIG. 8.

First, the processing flow of FIG. 8 will be described.

(Step S401) First, the measuring unit 106 measures the congestion degree of channels that interfere with the channel that the measuring unit 106 uses for communication.

(Step S402) The measuring unit 106 then stores the measured congestion degree of the interference channels in the storage unit 107.

A description is now given of the processing flow of a flow chart of FIG. 9. The processing flow is executed when some kind of communication request is generated.

Since processing in steps S501 to S502 is identical to the processing in steps S301 to S302 of FIG. 3, a description thereof is omitted.

(Step S503) Next, the determining unit 108 reads out the congestion degree of the interference channels and a predetermined congestion degree threshold value stored in the storage unit 107.

(Step S504) The determining unit 108 then determines whether or not the congestion degree of the interference channels is below the predetermined threshold value. If the congestion degree of the interference channels is below the predetermined congestion degree threshold value (YES), it means that the interference to the channel used for communication is small, the determining unit 108 then proceeds to step S505. If the congestion degree of the interference channels is above the predetermined congestion degree threshold value (NO), it means that the interference to the channel used for the communication is large, the determining unit 108 then interrupts execution of the request and ends the processing.

Since processing in steps S505 to S508 is identical to the processing in steps S303 to S306 of FIG. 3, a description thereof is omitted.

In FIG. 9, confirmation processing is performed only once before communication is executed. However, the confirmation processing may be performed whenever communication is executed as in FIG. 4.

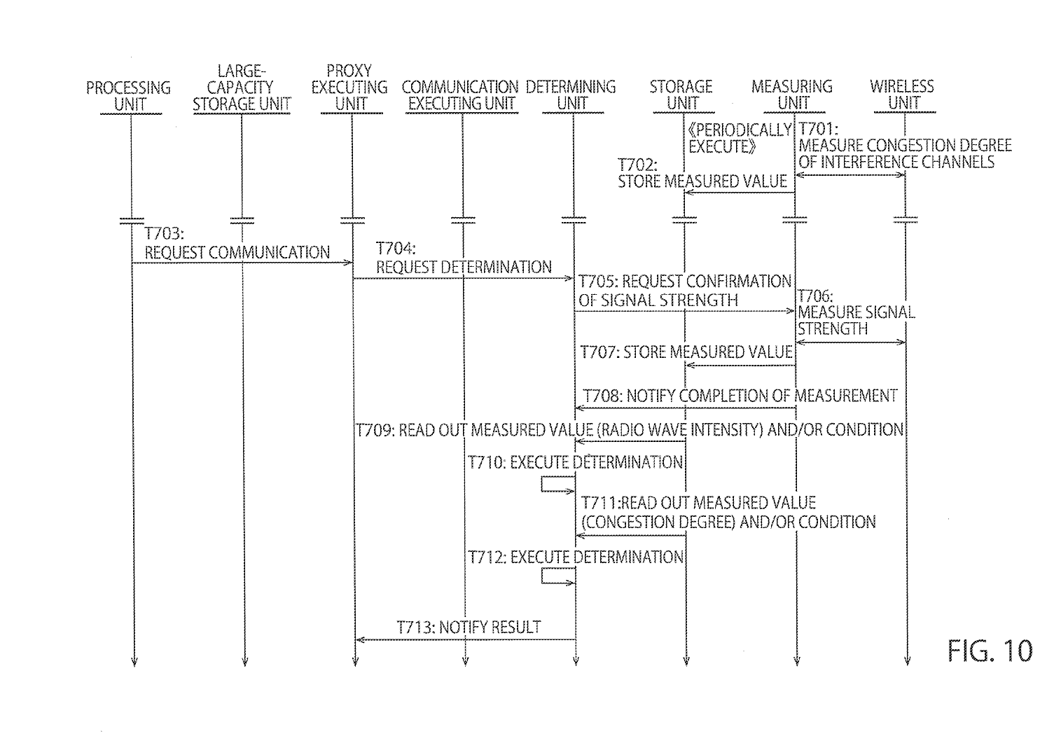

FIG. 10 is an operation sequence chart for each component member corresponding to the flow charts of FIGS. 8 and 9. The communication apparatus 100 periodically executes the following processing of T701 and T702.

(T701) First, the measuring unit 106 measures the congestion degree of channels that interfere with the channel used for communication.

(T702) The measuring unit 106 then stores the measured congestion degree of the interference channels in the storage unit 107.

(T703) when a communication request is generated in the processing unit 101, the processing unit 101 requests execution of communication to the proxy executing unit 102.

(T704) Next, the proxy executing unit 102 which received the request requests the determining unit 108 to determine whether or not to execute the communication based on a current radio wave intensity and congestion degree of the interference channels.

(T705) Next, the determining unit 108 requests the measuring unit 106 to measure the current received signal strength.

(T706) Next, the measuring unit 106 which received the request obtains a value of the received signal strength from the wireless unit 105.

(T707) The measuring unit 106 then stores the value of the received signal strength in the storage unit 107.

(T708) At the same time, the measuring unit 106 notifies completion of measurement to the determining unit 108.

(T709) Upon reception of the completion of measurement, the determining unit 108 reads out from the storage unit 107 a measured value (received signal strength) and a condition (e.g., a predetermined threshold value such as those described in FIG. 5A) for determination.

(T710) The determining unit 108 then determines whether or not the measured received signal strength is above the predetermined threshold value read out from the storage unit 107.

(T711) The determining unit 108 then reads out from the storage unit 107 a measured value (congestion degree of interference channels) and a condition (for example, a predetermined congestion degree threshold value) for determination.

(T712) The determining unit 108 then determines whether or not the congestion degree of interference channels is below the predetermined congestion degree threshold value read out from the storage unit 107.

(T713) Next, the determining unit 108 notifies the result to the proxy executing unit 102.

According to the description of FIG. 10, the determining unit 108 reads out the measured value of the radio wave intensity separately from the measured value of the congestion degree from the storage unit 107. However, the determining unit 108 may read out both the values at once.

Although the operation has been described by taking the congestion degree for example, the same operation can be implemented by using other indices.

In the above example, the operation has been described with the attention being focused on a relation between the channel that is directly used and the channels interfering the former channel. However, the attention may be focused on a relation between the channel and other interference radio waves which are out of wireless LAN standards.

Here, a description is given of the case, as an example, where the parameter relating to the third communication channel is the intensity of a radio wave in a frequency band similar or adjacent to the frequency used in communication with the wireless access network apparatus 201.

The radio wave in the frequency band similar or adjacent to the frequency used in communication with the wireless access network apparatus 201 is, for example, a radio wave in a 2.4 GHz bandwidth which is emitted by microwave ovens, cordless handsets, and the like. Since the radio waves emitted by those of the equipment are interference radio waves, such phenomenon as deteriorated SNR can be observed. Therefore, the determining unit 108 can use the received signal strength and SNR in the same processing as described before to determine appropriateness of data acquisition by the communication unit 110.

Thus, not only the status of the communication channel that is directly used in communication but also the status of adjacent communication channels are grasped. As a result, it becomes possible to appropriately detect a case where efficient communication cannot be performed even with a high radio wave intensity. Accordingly, communication identified by instruction information can efficiently be executed.

### Second Embodiment

Hereinafter, a second embodiment will be described. In the first embodiment, appropriateness of starting communication is determined by using only the information with respect to the radio wave obtained from the wireless LAN interface. Contrary to this, in the second embodiment, control is executed also in consideration of an application-level throughput.

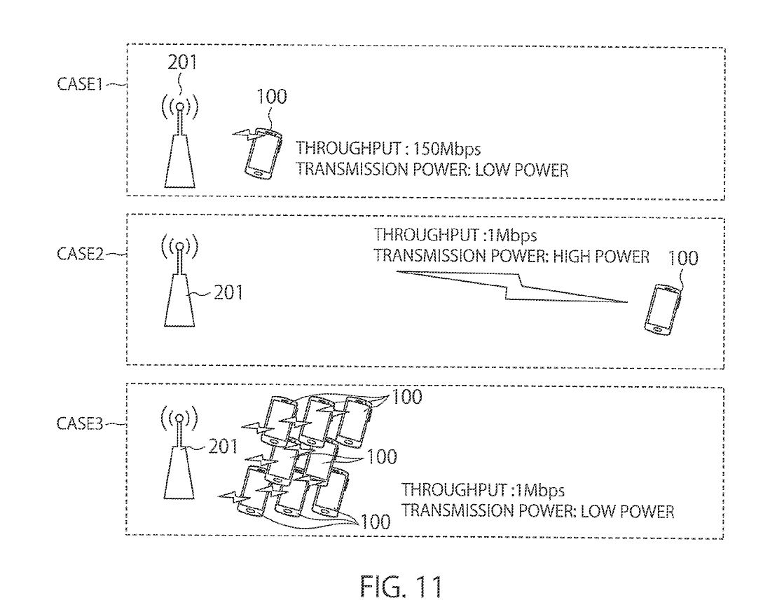

FIG. 11 is an explanatory view illustrating issues in the second embodiment. In CASE 1 of FIG. 11, one communication apparatus 100 is present, and a distance from the communication apparatus 100 to the wireless access network apparatus 201 is short, so that the throughput is as high as 150 Mbps. Since the distance from the communication apparatus 100 to the wireless access network apparatus 201 is short, the communication apparatus 100 can keep the level of transmission power low. In this case, power consumption can be suppressed. The throughput here refers to the amount of reception data per unit time.

In CASE 2 of FIG. 11, one communication apparatus 100 is present, and the distance from the communication apparatus 100 to the wireless access network apparatus 201 is long, so that the throughput is as low as 1 Mbps.

In CASE 3 of FIG. 11, the distance from the communication apparatus 100 to the wireless access network apparatus 201 is short. Therefore, the communication apparatus 100 can keep the level of transmission power low, so that power consumption can be suppressed. However, unlike the CASE 1, eight communication apparatuses 100 simultaneously may perform radio communication with the wireless access network apparatus 201. Then, even though the distance from the eight communication apparatuses 100 to the wireless access network apparatus 201 is short, a wireless link is crowded and the throughput may possibly become lower, for example 1 Mbps. Thus, when a large number of the communication apparatuses 100 simultaneously perform radio communication with one wireless access network apparatus 201, a problem of the crowded line and lowered throughput occurs even though the distance from the communication apparatuses 100 to the wireless access network apparatus 201 is short and the received signal strength is high.

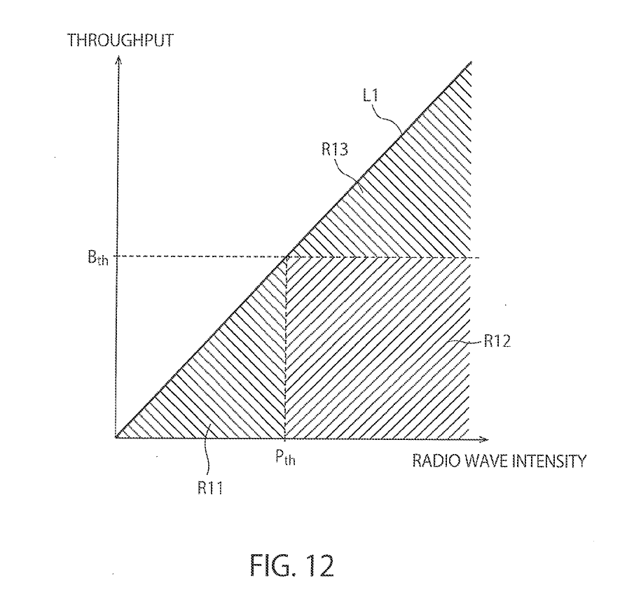

As compared with these cases, in the present embodiment, conditions of prefetching include not only the range of the radio wave intensity but also the range of the throughput as illustrated in FIG. 12.

FIG. 12 is an explanatory view of the conditions for prefetching. In FIG. 12, the ordinate represents a throughput and the abscissa represents a radio wave intensity. A straight line L1 connects the origin and a point (“Pth”, “Bth”). “Pth” denotes a threshold value of the radio wave intensity, while “Bth” denotes a threshold value of the throughput.

A region R11 which is out of an initial data acquisition range is a region where the radio wave intensity is smaller than the radio wave intensity threshold value “Pth,” and the throughput is equal to or below a throughput obtained from the straight line L1.

A region R12 which is in the initial data acquisition range but out of a prefetching range is a region where the radio wave intensity is equal to or above the radio wave intensity threshold value “Pth,” and the throughput is below the throughput threshold value “Bth.”

A region R13 which is in the range of prefetching is a region where the radio wave intensity is equal to or above the radio wave intensity threshold value “Pth,” the throughput is equal to or above the throughput threshold value “Bth” and is also equal to or below the throughput obtained from the straight line L1.

Hereinafter, one example of the processing will be described.

When the communication unit 110 receives an information acquisition request from a request source (the processing unit 101 in one example), the communication unit 110 acquires the information from the corresponding apparatus 202 by radio communication, and extracts a URL from the acquired information.

The determining unit 108 then determines, based on a plurality of parameters, whether or not to acquire data (for example, image or movie data) corresponding to the extracted URL from the corresponding apparatus 202, before reception of the request from the request source (the processing unit 101 in one example). In the case of the example of FIG. 12, the determining unit 108 makes determination based on the received signal strength and the throughput.

When the determining unit 108 determines to acquire the information before reception of the request from the request source (the processing unit 101 in one example), the communication unit 110 acquires the data corresponding to the URL from the corresponding apparatus 202 by radio communication, and returns the acquired information and the acquired data to the request source (the processing unit 101 in one example). Accordingly, the processing unit 101 can display a WEB page with image and/or movie data embedded therein on a display unit not illustrated.

When the determining unit 108 determines not to acquire the information before reception of the request from the request source, the communication unit 110 returns the acquired information to the request source (the processing unit 101 in one example). Accordingly, the processing unit 101 can display a WEB page with image and/or movie data not embedded therein on the display unit not illustrated.

A block diagram of the present embodiment is the same as the first embodiment (FIG. 1). However, the present embodiment is different from the first embodiment in the point that the measuring unit 106 is capable of performing not only measurement with respect to the wireless LAN but also measurement at the application level. More specifically, the measuring unit 106 measures the throughput by recording, for example, start time, finish time, and a transmission and reception data amount of the communication performed by the communication executing unit 104.

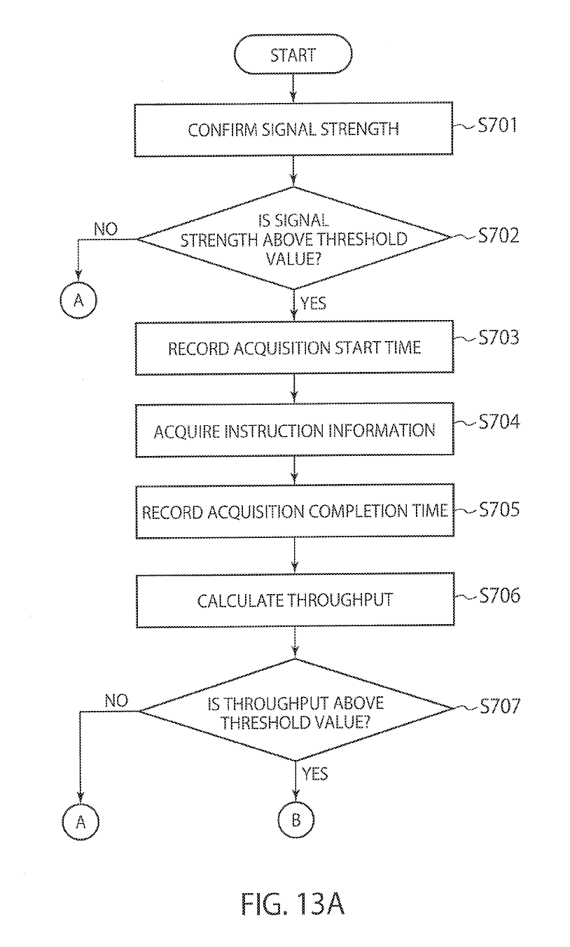

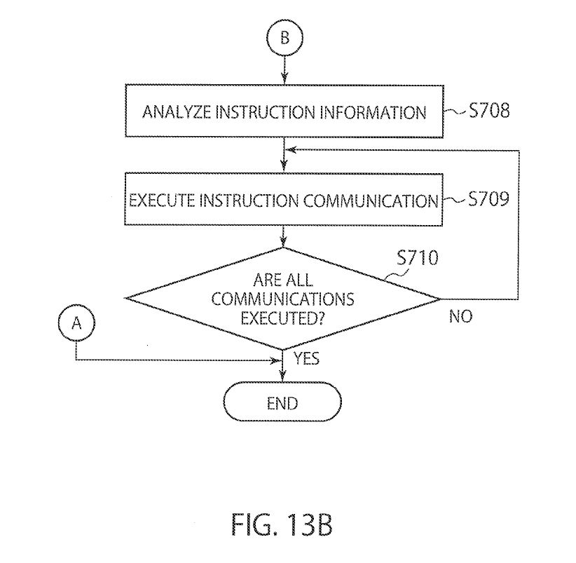

FIG. 13A is a flow chart illustrating an example of the processing flow of the communication apparatus 100 in a modification of the second modification. FIG. 13B is a flow chart continued from the flow chart of FIG. 13A. Most parts of FIG. 13A and FIG. 13B are similar to the first embodiment illustrated in FIG. 3. Since the processing in steps S701 to S702 of FIG. 13A is identical to the processing in steps S301 to step S302 of FIG. 3, a description thereof is omitted. Since the processing in steps S708 to S710 of FIG. 13B is identical to the processing in steps S304 to step S306 of FIG. 3, a description thereof is omitted.

A modified point in FIG. 13A is addition of steps S703 to S707. Hereinafter, the added steps will be described.

(Step S703) The measuring unit 106 records the time of starting acquisition of the instruction information.

(Step S704) Next, the communication unit 110 acquires instruction information. At the time of acquiring the instruction information from a server, the communication unit 110 grasps the size of the instruction information so as to obtain data necessary for calculating the throughput.

(Step S705) Next, the measuring unit 106 records the time of finishing acquisition of the instruction information.

The processing in step S703 and step S705 is for recording communication time necessary for calculating the throughput, which is used in step S706.

(Step S706) The measuring unit 106 then calculates the throughput with use of these pieces of information in accordance with (size of acquired instruction information)/{(communication finish time)−(communication start time)}.

(Step S707) Next, the determining unit 108 determines whether or not the calculated throughput is above a preset threshold value. If the throughput is above the threshold value as a result of determination (YES), the determining unit 108 proceeds to step S708. Accordingly, analysis of the instruction information and communication based on the instruction are executed (S708 to S709). If the throughput is below the threshold value (NO), the determining unit 108 ends the processing without executing analysis of the instruction information and communication based on the analysis.

The threshold value used for comparison with the throughput is to be stored in the storage unit 107 or a memory not illustrated as in the case of the information of the radio wave intensity in the first embodiment.

What is described above is the basic operation of the present embodiment. Since the operating sequence of each component member is substantially identical to that in the first embodiment, a description thereof is omitted.

The measuring unit 106 measures a received signal strength and a throughput of the radio communication performed to acquire instruction information. The determining unit 108 determines whether or not to acquire data corresponding to a URL extracted from the instruction information, based on the received signal strength and the throughput acquired by measurement made by the measuring unit 106. As a consequence, when the reception radio wave and the throughput are high, the determining unit 108 permits acquisition of the data corresponding to the URL, and the processing unit 101 acquires image or movie data embedded in a WEB page by communication. When the received signal strength is low and/or the throughput is low, the determining unit 108 does not permit acquisition of the data corresponding to the URL, and the processing unit 101 does not acquire image or movie data embedded in a WEB page by communication.

When the determining unit 108 determines not to permit data acquisition, the processing unit 101 may acquire only a part of image or movie data embedded in a WEB page by communication.

As described in the foregoing, in the second embodiment, the measuring unit 106 measures a communication state of the radio communication performed to acquire instruction information as a measuring target. The determining unit 108 determines whether or not to acquire data corresponding to the URL extracted from the instruction information, based on a plurality of parameters with respect to the communication state obtained by measurement made by the measuring unit 106. Accordingly, if the communication state in the radio communication performed to acquire the instruction information is favorable, the communication unit 110 acquires the data corresponding to each URL. If the communication state in the radio communication performed to acquire the instruction information is not favorable, the communication unit 110 does not acquire the data corresponding to each URL. Accordingly, the data corresponding to the URL is acquired only when the communication state in the radio communication performed to acquire the instruction information is favorable. This makes it possible to reduce communication time for acquiring the data corresponding to the URL and to decrease power consumption in the communication apparatus 100.

<Modification of Second Embodiment: Calculating Throughput a Plurality of Times>

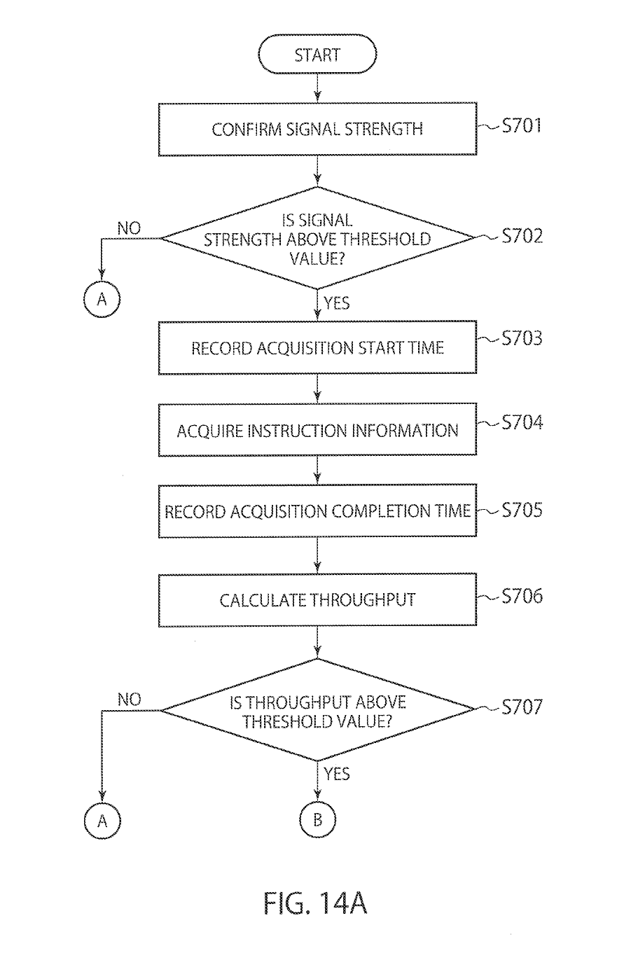

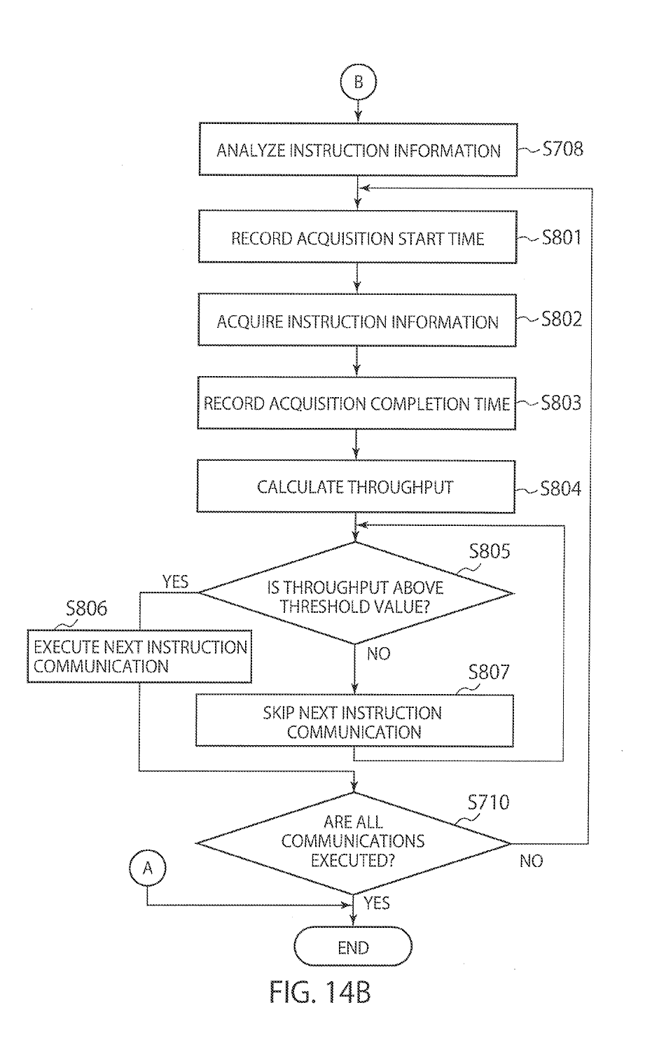

In the above description, the communication apparatus 100 calculates the throughput when the instruction information is acquired, and determines whether or not to perform subsequent communication based thereon. In contrast with this, in one or more communications in relation to transmission and reception of the instruction information, determination of the throughput may be performed whenever one time of communication is completed. In that case, the throughput of the communication executed immediately before is measured, and appropriateness of the next communication is determined based on the measured throughput (added steps S801 to S806 in FIG. 14).

FIG. 14A is a flow chart illustrating an example of the processing flow of the communication apparatus 100 in a modification of the second modification. FIG. 14B is a flow chart continued from the chart of FIG. 13A. Since processing in steps S701 to S707 of FIG. 14A is identical to the processing in steps S701 to S707 of FIG. 13A, a description thereof is omitted. Since processing in steps S708 and S710 of FIG. 14B is identical the processing in steps S708 and step S710 of FIG. 13B, a description thereof is omitted. Since processing in steps S801 to S804 is identical to the processing in steps S703 to S706 of FIG. 13A (FIG. 14A), a description thereof is omitted.

(Step S805) Next, the determining unit 108 determines whether or not the throughput in the last communication calculated in step S804 is above a predetermined threshold value. If the throughput in the last communication is above the threshold value (YES), the determining unit 108 proceeds to step S806. If the throughput in the last communication is equal to or below the threshold value (NO), the determining unit 108 proceeds to step S807.

(Step S806) When the throughput in the last communication is determined to be above the threshold value in step S805, the communication unit 110 executes next instruction communication. In that case, in order to obtain the criterion of determination for the subsequent communication, the throughput is measured.

(Step S807) When the throughput in the last communication is determined to be equal to or below the threshold value in step S805, the communication unit 110 skips the next instruction communication.

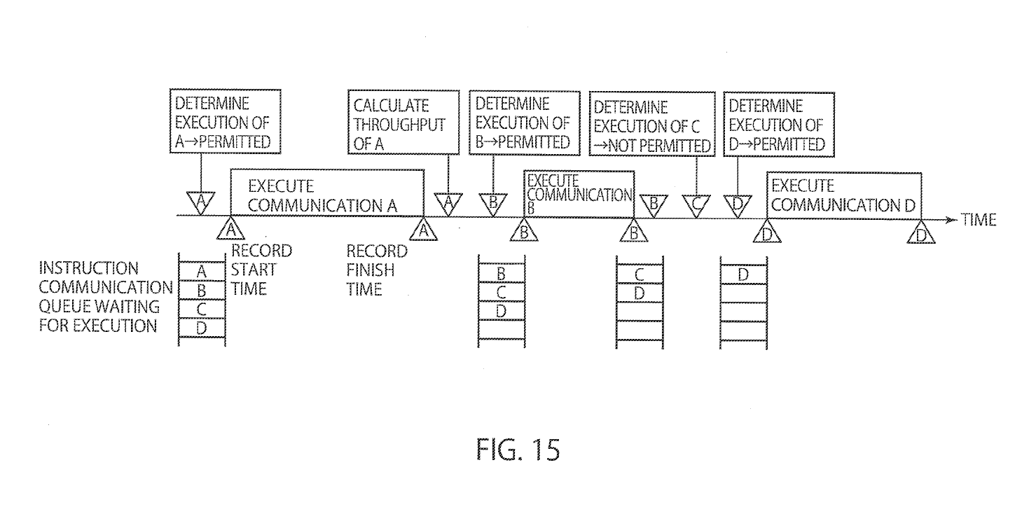

When a waiting queue of instruction communication is configured like a FIFO queue, determination of communication appropriateness is performed on an instruction communication at the head of the queue. If the value of the instruction communication at the head of the queue is below its threshold value, the instruction communication is discarded, and the focus is shifted to next instruction communication. In this case, if the threshold values for all the instruction communications are the same, all the instruction communications are discarded and the processing is ended. In contrast, when the threshold values are different for each instruction communication as described in the first embodiment (FIG. 5), the processing is executed while executable instruction communication is searched during repeated execution of the steps S805 and S806 (see FIG. 15).

FIG. 15 illustrates four communications, A, B, C, and D being stored in a queue as instruction communications waiting for execution, being subjected to execution determination, and being executed. In FIG. 15, it is premised that the determining unit 108 has already determined that the received signal strength is over a predetermined threshold value. The determining unit 108 first performs execution determination of the communication A by using a throughput obtained from the instruction information acquisition processing to be executed at first. Once the communication A is executed, a throughput in the communication A can be calculated, so that determination of the communication B which is a next entry in the queue can be executed.

In FIG. 15, it is assumed that the execution is permitted, so that execution of the communication B by the communication unit 110 and calculation of a throughput by the measuring unit 106 are performed. Next, the determining unit 108 makes determination of the communication C by using the throughput of the communication B. In FIG. 15, execution of the communication C is not permitted. In accordance with the determination, the communication C is removed from the queue by the communication unit 110, and the determining unit 108 shifts to determination of the communication D which is a next entry. If all the communications share one threshold value, they also share one throughput that is to be used for comparison, and therefore the communication D is also not permitted. However, in the case of FIG. 15, it is assumed that a plurality of threshold values are set and execution of the communication D is permitted.

Thus, the communication unit 110 performs communication to sequentially acquire data corresponding to a URL. Whenever communication is performed to acquire data corresponding to a URL, the measuring unit 106 measures the received signal strength and the throughput. The determining unit 108 then determines whether or not to acquire data corresponding to a next URL, based on the received signal strength and the throughput acquired by measurement made by the measuring unit 106. When the determining unit 108 determines to acquire the data, the communication unit 110 acquires the data corresponding to the next URL. On the other hand, when the determining unit 108 determines not to acquire the data, the communication unit 110 does not acquire the data corresponding to the next URL. In this way, the determining unit 108 determines whether or not to acquire data whenever communication to acquire data corresponding to a URL is performed. The determining unit 108 determines whether or not to acquire data in accordance with a network environment on each occasion. As a consequence, data acquisition can be avoided when the network environment is not favorable, so that power consumption in the communication apparatus 100 can be suppressed.

<Supplementary 1 to Second Embodiment: Types of Information to be Used>

In the second embodiment described thus far, the radio wave intensity and the application-level throughput are used as the conditions for use in determination. Out of these, the radio wave intensity may be used together with other parameters relating to radio as described before, or other parameters (for example, the congestion degree and SNR) may be used by themselves. In the case of using other parameters together with the radio wave intensity, the determining unit 108 may evaluate, for example, the radio wave intensity and the congestion degree/SNR in this order, to determine appropriateness of data acquisition by the communication unit 110 as described in the modification of the first embodiment

In the case of using a plurality of parameters relating to radio, the priority of the parameters conforms to the followings. A first parameter having a first priority is a parameter relating to a communication channel (radio section) which is directly used in communication. In other words, the first parameter is a parameter relating to the first communication channel directly connected to the communication apparatus 100. Examples of the first parameter include a received signal strength and a link rate of the communication apparatus 100, or a congestion degree of the first communication channel directly connected to the communication apparatus 100.

The link rate here refers to a transfer rate of a physical layer determined based on association between the communication apparatus 100 and the wireless access network apparatus 201. The congestion degree of the communication channel refers to, for example, a ratio of radio wave transmitting time (radio wave reception time in relation to the communication apparatus 100) to radio wave transmittable time in a channel used by the communication apparatus 100 and the wireless access network apparatus 201.

A second parameter having a second priority is a parameter relating to an interference radio wave from other equipment that uses a frequency band similar or adjacent to the frequency used for communication with the wireless access network apparatus 201, and/or a parameter relating to an adjacent communication channel that is adjacent to the communication channel directly used for communication with the wireless access network apparatus 201. The second parameter is one example of the parameter relating to the third communication channel.

Examples of the parameter relating to the adjacent communication channel include a congestion degree, an SNR and an SIR of the adjacent communication channel, or a radio wave intensity in a radio communication channel that is adjacent to the radio communication channel used for communication with the wireless access network apparatus 201.

The determining unit 108 may perform determination by using not only the application throughput but also information that can be measured in the measuring unit 106 by referring to the information in the communication executing unit 104, such as a packet loss, the number of retransmissions, a delay, a round trip time (RTT), and a fluctuation of these parameters. These parameters may be used as a condition in place of the throughput or may be used as an additional condition.

In the case of using the packet loss in place of the throughput, the determining unit 108 does not permit data acquisition by the communication unit 110 if the number of generated packet losses is equal to or above a given threshold value. Otherwise, the determining unit 108 may permit data acquisition by the communication unit 110. The number of retransmissions, the delay, and the RTT are also the parameters which are preferable if they are smaller. Accordingly, the determining unit 108 may determine appropriateness of data acquisition by the communication unit 110 based on a magnitude relation between the number of packet losses and at least one of the number of retransmissions, the delay, and the RU and its preset threshold value. Specifically, if at least one of the number of retransmissions, the delay, and the RU is above its threshold value, the determining unit 108 does not permit data acquisition by the communication unit 110. If all of the number of retransmissions, the delay, and the RU are equal to or below their threshold values, the determining unit 108 may permit data acquisition by the communication unit 110

In the case of using the parameters as an additional condition, they may be used as a supplementary to the throughput information. For example, when a large number of packet losses and/or retransmissions is generated even though the throughput is high, communication efficiency may be degraded. In that case, the determining unit 108 may determine that the environment is not adequate for execution of the instruction communication.

These pieces of information can be obtained from TCP/IP statistical information (such as the number of transmission and reception packets, the number of error packets, and the number of retransmissions in each interface) managed in the communication executing unit 104.

In the case of using a plurality of radio-related parameters described in the first embodiment and using a plurality of application-level parameters described in the present embodiment, the determining unit 108 may make determination by using the radio-related parameters, and then make determination by using the application-level parameters.

As described in the foregoing, the first parameter may be a parameter indicative of the intensity of a signal from the wireless access network apparatus 201 connected to the communication apparatus 100. The second parameter is a parameter relating to communication channels including a second communication channel. The parameter relating to the communication channels including the second communication channel is a parameter indicative of any one of a rate in a logical communication channel with the corresponding apparatus and a delay in a logical communication channel with the corresponding apparatus 202, or a fluctuation of the rate or the delay.

<Supplementary 2 to Second Embodiment: Frequency of Calculation and Determination, and Granularity of Throughput>

In FIGS. 14A and 14B, measurement of the radio wave intensity is performed only once in the first communication, while measurement of the throughput is performed in each communication. This is merely an example and measurement and determination of the radio wave intensity may also be performed in each communication. Conversely, measurement of the radio wave intensity may be performed in each communication, while measurement of the throughput may be performed only once in the first communication. Furthermore, as in the case of the first embodiment, a plurality of threshold values may be provided for the throughput so as to control execution of the instruction communication.

Furthermore, the measuring unit 106 may calculate the throughput for use in comparison with its threshold value in the corresponding apparatus 202 (such as a server) or in a belonging network to which the corresponding apparatus 202 belongs. For example, in the case of calculating the throughput in each belonging network, the measuring unit 106 may calculate the throughput, for example, for each domain name or each IP address.

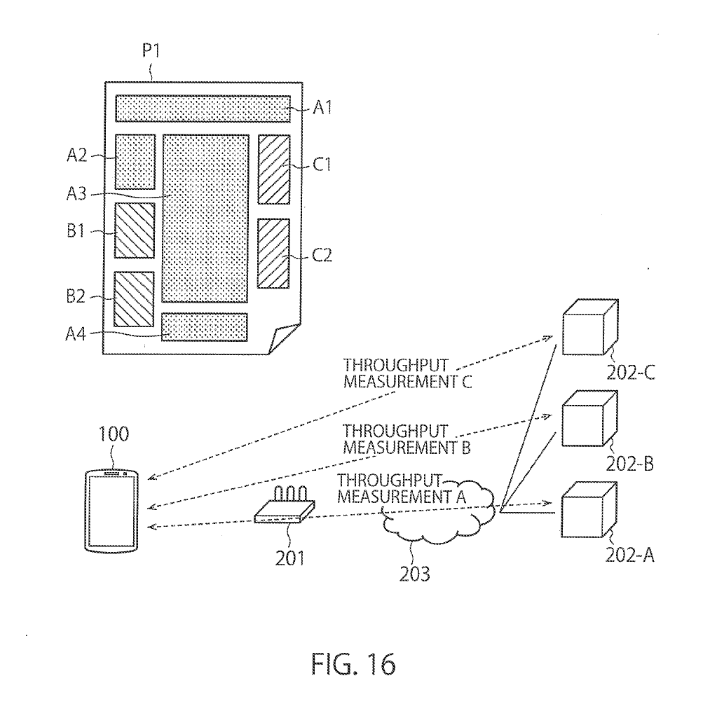

Now, processing of calculating the throughput in each server that is used as a communication counterpart is described with reference to FIG. 16. FIG. 16 is an explanatory view of the processing of calculating the throughput for each server used as a communication counterpart. An example of FIG. 16 represents the case of acquiring information included in a web page made up of eight elements. In the example of FIG. 16, the instruction information is an HTML file of a web page, and the instruction communication is communication to acquire image data placed on the HTML file.

In the example of FIG. 16, components A1 to A4 in the WEB page P1 are classified into a group A, components B1 and B2 are classified into a group B, and components C1 and C2 are classified into a group C. The data of the components A1 to A4 classified into the group A is stored in a server 202-A. The data of the components B1 and B2 classified into the group B is stored in a server 202-B. The data of the components C1 and C2 classified into the group C is stored in a server 202-C.

In such circumstances, the throughput may different in each server. If a sufficient throughput cannot be acquired in communication with a server that stores large data such as moving images, it may lead to waste of energy.

Accordingly, a method for measuring the throughput in each group may be employed. In this case, for example, the determining unit 108 uses the throughput, which was measured in the communication performed to acquire data of the component A1 in the group A, for determining appropriateness of the communication which acquires data of the component A2. Similarly, for example, the determining unit 108 uses the throughput, which was measured in the communication performed to acquire data of the component B1 in the group B, for determining appropriateness of the communication which acquires data of the component B2.

Hereinafter, a description is given of an example of the processing in each unit when the parameters relating to the communication state are calculated for each corresponding apparatus.

A plurality of corresponding apparatuses are present, and the communication unit 110 performs communication to sequentially acquire data corresponding to a URL. The measuring unit 106 measures a communication state of every communication that acquires data corresponding to a URL. The determining unit 108 determines, for each of the corresponding apparatuses, whether or not to acquire data corresponding to a next URL from a target corresponding apparatus, based on a plurality of parameters with respect to the communication state measured for the communication performed with the target corresponding apparatus.

A description is now given of an example of the processing in each unit when the parameters relating to the communication state are acquired for each belonging network to which the corresponding apparatus belongs. A plurality of the corresponding apparatuses 202 are present, and the communication unit 110 performs communication to sequentially acquire data corresponding to a URL. The measuring unit 106 measures a communication state of each communication that acquires data corresponding to a URL. The determining unit 108 determines, for each belonging network, whether or not to acquire data corresponding to a next URL from a corresponding apparatus included in a target belonging network, based on a plurality of parameters with respect to a communication state measured for the communication performed with the corresponding apparatus included in the target belonging network.

For example, when a plurality of communications are simultaneously performed, such as communications to acquire a plurality of image data sets embedded in a WEB page, the measuring unit 106 may integrate all the communications for the data sets and calculate the throughput of the integrated communication. For example, first image data has a data size of “D1” and second image data has a data size of “D2.” When communication takes time “T1” to simultaneously acquire the first image data and the second image data, the measuring unit 106 may obtain the throughput by calculating (D1+D2)/T1.

In that case, the measuring unit 106 may calculate the throughput not by measuring the start time and the finish time of a specific communication, but by recording the amount of received data in a certain predetermined period.

When the instruction communications are divided into a plurality of groups based on domains, IP addresses or the like, the measuring unit 106 may calculate the throughput with use of the total amount of received data in each group.

### Third Embodiment

Hereinafter, a third embodiment will be described. According to the first and second embodiments described so far, the instruction communication which did not fulfill the conditions is discarded. As compared with this, the instruction communication is made to wait for a predetermined period in the third embodiment, before a retry is attempted

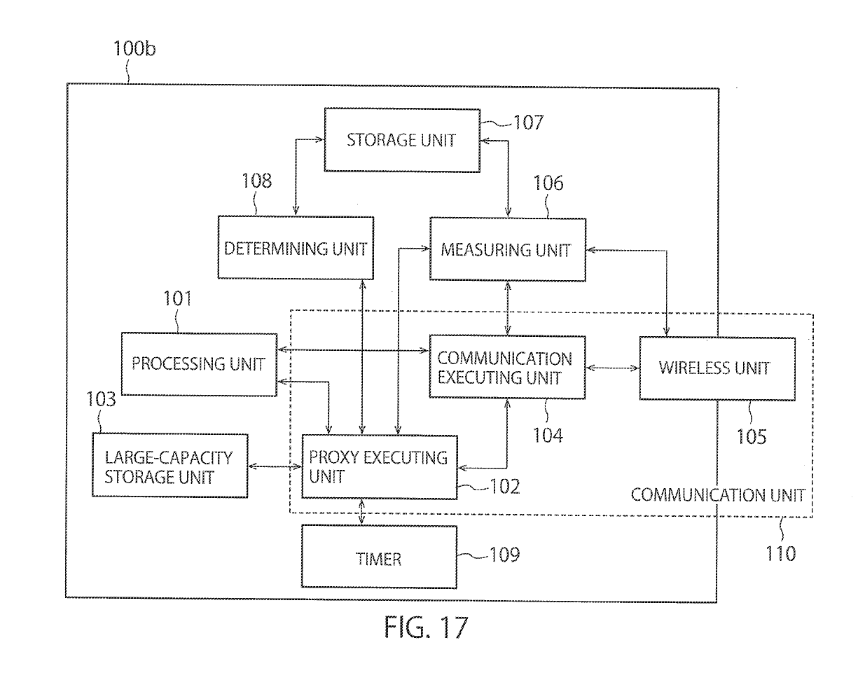

FIG. 17 is a schematic block diagram illustrating the configuration of a communication apparatus 100b in the third embodiment. It is to be noted that component members identical to those in FIG. 2 are designated by identical reference characters to omit a concrete description thereof. The configuration of the communication apparatus 100b in the third embodiment is similar to the configuration of the communication apparatus 100 in the first embodiment except the point that a timer 109 electrically connected to the proxy executing unit 102 is added.

The timer 109 is configured to count predetermined waiting time with respect to the communication which is determined to be unexecutable and which has waiting time set thereto.

As is the case of FIG. 2, the configuration of the communication apparatus 100b in FIG. 17 is merely an example, and component members included in the communication unit 110 is varied. Component members other than the processing unit 101 may be included in the communication unit 110.

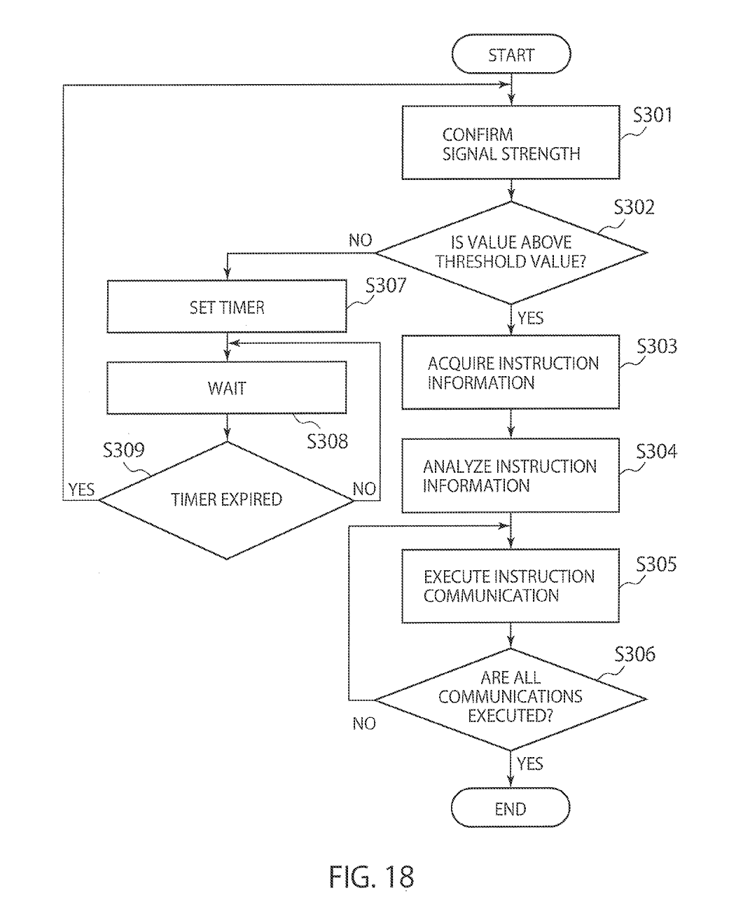

FIG. 18 is a flow chart illustrating a first example of the process flow of the communication apparatus 100b in the third embodiment. Although the flow chart is a modification of the first embodiment, it may also be applied to the second embodiment. Since processing in steps S301 and S303 to S306 is identical to the processing in steps S301 and S303 to S306 of FIG. 3, a description thereof is omitted. This processing flow is executed when some kind of communication request is generated.

(Step S302) The determining unit 108 determines whether the received signal strength measured in step S301 is above a predetermined threshold value. If the received signal strength is above the predetermined threshold value (YES), the determining unit 108 proceeds to step S303. If the received signal strength is equal to or below the predetermined threshold value (NO), the determining unit 108 proceeds to step S302. This is the point different from the step S302 of FIG. 3.

(Step S307) When the received signal strength is determined to be equal to or below the predetermined threshold value in step 302, the proxy executing unit 102 sets the timer 109.

(Step S308) The proxy executing unit 102 then waits for a predetermined time.

(Step S309) Then, the proxy executing unit 102 determines whether or not the timer 109 has expired. If the timer 109 has expired (YES), the proxy executing unit 102 returns to step S301 in order to confirm the radio wave intensity again. If the timer 109 has not expired (NO), the proxy executing unit 102 returns to step S308 to wait further.

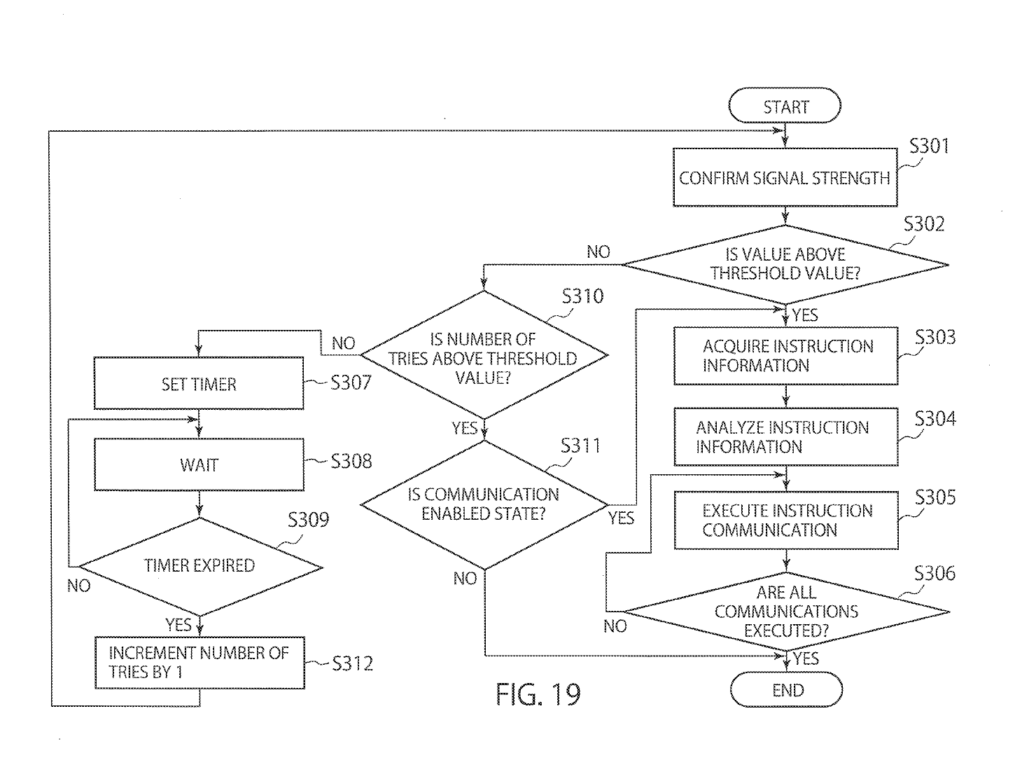

As illustrated in FIG. 19, a step of confirming the number of retries may be added as a process for the case where communication cannot be executed under an adequate environment in a desired time.

FIG. 19 is a flow chart illustrating a second example of the processing flow of the communication apparatus 100b in the third embodiment. In FIG. 19, communication processing is performed if communication is possible even if the radio wave intensity is low. In FIG. 19, steps added to FIG. 18 are S310 to S312. These added steps will be described below. The number of tries is presumed to be reset to 0 before the processing of step S301 is started.

(Step S310) When the received signal strength is determined to be equal to or below the predetermined threshold value in step 302, the determining unit 108 determines whether or not the number of tries is above a threshold value. If the number of tries is above the threshold value (YES), the determining unit 108 proceeds to step S311. If the number of tries is equal to or below the threshold value (NO), the determining unit 108 proceeds to step S307.

(Step S311) When it is determined that the number of tries is above the threshold value in step S310, the determining unit 108 determines whether or not the communication unit 110 is a communication enabled state. If the communication unit 110 is in the communication enabled state (YES), the determining unit 108 proceeds to step S303. If the communication unit 110 is not in the communication enabled state (NO), the determining unit 108 interrupts execution of the request, and ends the processing.

(Step S312) When it is determined that the timer 109 has been expired in step S309, the proxy executing unit 102 increments the number of tries by 1, and returns to step S301.

Here, it is assumed that an upper limit of the number of tries and the waiting time are set in advance.

The communication apparatus 100b performs processing to execute communication if it is in the communication enabled state even though the radio wave intensity is low. However, the present invention is not limited to this configuration. The communication apparatus 100b may display a screen, which asks a user about whether or not to perform communication, on a display unit not illustrated. The communication apparatus 100b may also discard the communication.

In the third embodiment as described in the foregoing, the measuring unit 106 measures the communication state again when a predetermined waiting time has elapsed since the time when the determining unit 108 determined not to permit data acquisition by the communication unit 110. The determining unit 108 then determines appropriateness of data acquisition by the communication unit 110, based on a result of remeasurement made by the measuring unit 106. Accordingly, the communication apparatus 100b can perform radio communication when the communication environment becomes favorable. This makes it possible to reduce the time taken for data acquisition and to decrease power consumption for communication.

The determining unit 108 records the frequency of measurement made by the measuring unit 106 and determination made by the determining unit 108 in one communication. When the recorded frequency is more than a predetermined value, even if the condition used by the determining unit 108 in past determination is not fulfilled, the determining unit 108 permits data acquisition by the communication unit 110, or asks a user of the communication apparatus 100b about whether or not to perform communication, or discards the communication to be performed based on the instruction information. Accordingly, the situation where the one communication is not finished and the communication apparatus 100b infinitely keeps on waiting can be avoided.

The above-stated various processes according to the communication apparatus in each of the embodiments may be executed by recording a program, which is adapted to execute each processing of the communication apparatus in each of the embodiments, on a computer-readable recording medium, causing a computer system to read the program stored in the recording medium, and causing a processor to execute the program.

The “computer system” used herein may refer to a system including hardware, such as an OS and peripheral devices. In the case where a WWW system is used, the “computer system” includes a homepage provision environment (or a display environment). Moreover, the “computer-readable recording medium” refers to: a writable nonvolatile memory such as a flexible disk, a magneto-optical disk, a ROM, and a flash memory; a portable medium such as a CD-ROM; and a memory device such as a hard disk built in a computer system.

Furthermore, the “computer-readable recording medium” includes media that hold a program for a definite period of time like a volatile memory (for example, a dynamic random access memory (DRAM)) inside the computer system used as a server or a client when the program is transmitted via a network such as the Internet and/or a communication line such as a telephone line. The program may be transferred from a computer system, which stores the program in its storage device and the like, to another computer system via a transfer medium or via a transmitted wave in the transfer medium. The “transfer medium” that transfers the program herein refers to a medium having a function of transferring information, such as a network (communication network) such as the Internet and a communication line such as a telephone line. The program may also be adapted to implement a part of the above-stated function. Furthermore, the program may be so-called a differential file (differential program) which can implement the above-stated function in combination with a program already recorded on the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication apparatus, comprising:
a communication unit that performs radio communication with a corresponding apparatus;
a measuring unit that measures a communication state of the radio communication performed by the communicating unit; and
a determining unit that determines appropriateness of data communication with the corresponding apparatus performed by the communicating unit, based on a plurality of parameters with respect to the communication state obtained by measurement made by the measuring unit.

2. The communication apparatus according to claim 1, wherein
when an information acquisition request is received from a request source, the communication unit acquires the information from the corresponding apparatus by radio communication, and extracts a URL from the acquired information,
the determining unit determines whether or not to acquire data corresponding to the extracted URL from the corresponding apparatus, based on the plurality of parameters, and
when the determining unit has determined to acquire the data, the communication unit acquires the data corresponding to the URL from the corresponding apparatus by radio communication, and returns the acquired information and the acquired data to the request source.

3. The communication apparatus according to claim 2, wherein
the measuring unit measures a communication state toward the radio communication performed to acquire the information, and
the determining unit determines whether or not to acquire the data corresponding to the URL extracted from the information, based on the plurality of parameters with respect to the communication state obtained by measurement made by the measuring unit.

4. The communication apparatus according to claim 3, wherein
the communication unit performs communication that sequentially acquires data corresponding to the URL,
the measuring unit measures a communication state in each communication that acquires the data corresponding to the URL, and
the determining unit determines whether or not to acquire data corresponding to a next URL, based on the plurality of parameters with respect to the communication state obtained by measurement made by the measuring unit.

5. The communication apparatus according to claim 4, wherein
a plurality of the corresponding apparatuses are present, and
the determining unit determines, for each of the corresponding apparatuses, whether or not to acquire data corresponding to a next URL from a target corresponding apparatus, based on a plurality of parameters with respect to a communication state measured in communication performed with the target corresponding apparatus.

6. The communication apparatus according to claim 4, wherein
a plurality of the corresponding apparatuses are present, and
the determining unit determines, for each of belonging networks, whether or not to acquire data corresponding to a next URL from a corresponding apparatus included in a target belonging network, based on the plurality of parameters with respect to a communication state measured for communication performed with the corresponding apparatus included in the target belonging network.

7. The communication apparatus according to claim 1, wherein
the plurality of parameters used by the determining unit include:
a first parameter relating to a first communication channel to which directly connected to the communication apparatus directly connects; and
a second parameter relating to either communication channels including a second communication channel from the wireless access network apparatus to the corresponding apparatus when the communication unit communicates with the corresponding apparatus via the wireless access network apparatus, or a third communication channel having a frequency such that a frequency difference with respect to a frequency of the first communication channel, to which the communication apparatus directly connects, is within a predetermined range, and
the determining unit determines appropriateness of data communication with the corresponding apparatus performed by the communication unit, based on the first parameter and the second parameter.

8. The communication apparatus according to claim 7, wherein
the first parameter is a parameter indicative of an intensity of a signal from the wireless access network apparatus with which the communication apparatus connects,
the second parameter is a parameter relating to the third communication channel, and
the parameter relating to the third communication channel is a parameter relating to an interference radio wave from other equipment that uses a frequency band same or adjacent to a frequency used for communication with the wireless access network apparatus, and/or a parameter relating to an adjacent communication channel that is adjacent to the communication channel directly used for communication with the wireless access network apparatus.

9. The communication apparatus according to claim 8, wherein
the parameter relating to the adjacent communication channel includes a congestion degree, an SNR and an SIR of the adjacent communication channel, or a radio wave intensity in a radio channel that is adjacent to the radio channel used for communication with the wireless access network apparatus.

10. The communication apparatus according to claim 7, wherein
the first parameter is a parameter indicative of an intensity of a signal from the wireless access network apparatus with which the communication apparatus connects,
the second parameter is a parameter relating to the communication channels including the second communication channel, and
the parameter relating to the communication channels including the second communication channel is a parameter indicative of any of a rate in a logical communication channel with the corresponding apparatus, a delay in a logical communication channel with the corresponding apparatus and a fluctuation of the rate or the delay.

11. The communication apparatus according to claim 2, wherein
the determining unit determines appropriateness of data acquisition by the communication unit, based on comparison between a threshold value determined by any of a type of the data corresponding to the URL, a request source that made a request of transmission and reception, and a communication direction of the data corresponding to the URL, and the plurality of parameters with respect to the communication state obtained by measurement made by the measuring unit.

12. The communication apparatus according to claim 1, wherein
the measuring unit measures the communication state again, when a predetermined waiting time has elapsed from the time when the determining unit determines not to permit data acquisition by the communication unit, and
the determining unit determines appropriateness of data acquisition by the communication unit, based on a result of remeasurement made by the measuring unit.

13. The communication apparatus according to claim 12, wherein
the determining unit records frequency of measurement made by the measuring unit and of determination made by the determining unit for one communication, and
when the recorded frequency is above a predetermined value, even if the condition used by the determining unit in past determination is not fulfilled, the determining unit permits data acquisition by the communication unit, or asks a user of the communication apparatus about whether or not to perform communication, or discards the communication to be performed based on the information.

14. A communication method performed by a communication apparatus including a communication unit that performs radio communication with a corresponding apparatus, the method comprising:
a measuring unit measuring a communication state in radio communication performed by the communication unit; and
a determining unit determining appropriateness of data communication with the corresponding apparatus performed by the communicating unit, based on a plurality of parameters with respect to the communication state obtained by measurement made by the measuring unit.

15. A computer-readable storage medium storing a program that causes a communication apparatus including a communication unit that performs radio communication with a corresponding apparatus to function as:
a measuring unit that measures a communication state of the radio communication; and
a determining unit that determines appropriateness of data communication with the corresponding apparatus performed by the communicating unit, based on a plurality of parameters with respect to the communication state obtained by measurement made by the measuring unit.
